(19) United States
(12) Patent Application Publication
(10) Pub. No.: US 2015/0027839 A1
(43) Pub. Date: Jan. 29, 2015

(54) One-Way Clutch

(71) Applicant: Gates Corporation, Denver, CO (US)

(72) Inventor: Dean Schneider, Rochester Hills, MI (US)

(73) Assignee: Gates Corporation, Denver, CO (US)

(21) Appl. No.: 13/952,801

(22) Filed: Jul. 29, 2013

(51) Int. Cl. F16D 41/12

(52) U.S. Cl. CPC F16D 41/12
USPC 192/45.1

(57) ABSTRACT

A one-way clutch comprising a driver member, a driven member disposed radially outward of the driver member, a pawl cooperatively engaged with a receiving portion in the driver member, a recess in the driven member for receiving the pawl, a pawl guide engaged with the driven member, and the pawl engaged with the pawl guide, the pawl guide having a first portion and a second portion, the first portion urging the pawl radially outward to engage the recess for a driving condition and the second portion urging the pawl radially inward to disengage the recess for an overrun condition.

### FIELD OF THE INVENTION

The invention relates to a one-way clutch comprising a pawl guide engaged with a pawl having a first portion and a second portion, the first portion orienting the pawl radially outward into contact with a driven member recess for a driving condition and the second portion orienting the pawl radially inward out of contact with the recess for an overrun condition.

### BACKGROUND OF THE INVENTION

This invention relates to one-way clutches for rotating devices. Often rotating power transmission devices have the need for a one way clutch to allow free rotation in one direction and power transmission in the other rotating direction. It is common to incorporate a sprag type, roller type, or wrap-spring type one-way clutch in these devices. These common clutches can be complex, high precision, limited in capacity, require excessive space and can require precision mating components.

Representative of the art is U.S. Pat. No. 7,000,749 which discloses a ratchet one-way clutch. including an inner race, an outer race provided coaxially with the inner race, a pawl member for transmitting torque between the inner race and the outer race, and a damper mechanism for absorbing shock at the time of engagement of the pawl member, a sliding plate is interposed between two members which constitute the damper mechanism and are rotatable relative to each other.

What is needed is a one-way clutch comprising a pawl guide engaged with a pawl having a first portion and a second portion, the first portion orienting the pawl radially outward into contact with a driven member recess for a driving condition and the second portion orienting the pawl radially inward out of contact with the recess for an overrun condition. The present invention meets this need.

### SUMMARY OF THE INVENTION

The primary aspect of the invention is a one-way clutch comprising a pawl guide engaged with a pawl having a first portion and a second portion, the first portion orienting the pawl radially outward into contact with a driven member recess for a driving condition and the second portion orienting the pawl radially inward out of contact with the recess for an overrun condition.

Other aspects of the invention will be pointed out or made obvious by the following description of the invention and the accompanying drawings.

The invention comprises a one-way clutch comprising a driver member, a driven member disposed radially outward of the driver member, a pawl cooperatively engaged with a receiving portion in the driver member, a recess in the driven member for receiving the pawl, a pawl guide engaged with the driven member, and the pawl engaged with the pawl guide, the pawl guide having a first portion and a second portion, the first portion urging the pawl radially outward to engage the recess for a driving condition and the second portion urging the pawl radially inward to disengage the recess for an overrun condition.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a front view of the device.

FIG. 2 is an exploded view of the device.

FIG. 3a is a detail of the device in the driving condition.

FIG. 3b is a detail of the device in the overrun condition.

FIG. 4 is a perspective detail of the device.

FIG. 5 is a perspective view of an alternate embodiment.

FIG. 6 is an exploded view of the device.

FIG. 7 is a perspective view of an alternate embodiment.

FIG. 8 is a perspective view of an alternate embodiment.

FIG. 9 is an exploded view of an alternate embodiment.

### DETAILED DESCRIPTION OF THE PREFERRED EMBODIMENT

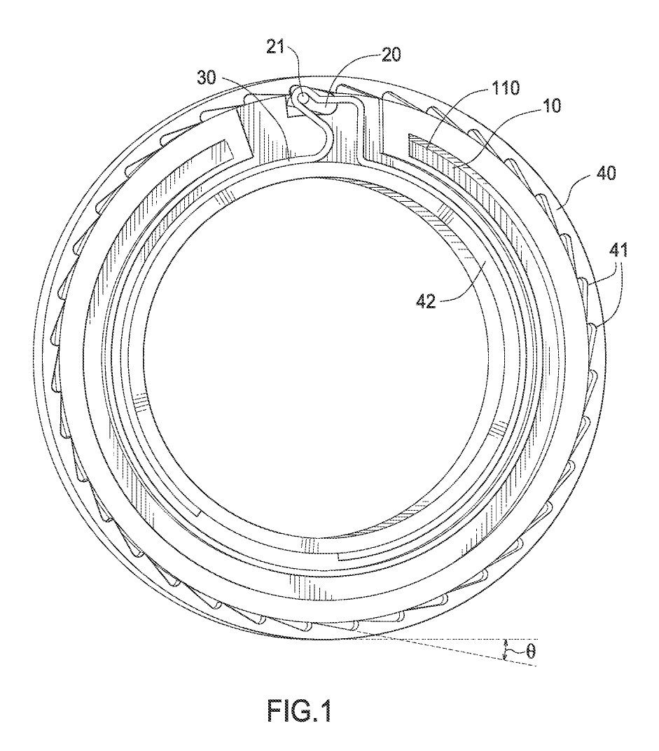

FIG. 1 is a front view of the device. The inventive device consists of a driver member 10, pawl 20, pawl guide 30 and a driven member 40. Driven member 40 is disposed radially outward of driver member 10. Driver member 10 is oriented such that it is in contact with the pawl 20. Pawl 20 is oriented such that it is in contact with driven member 40 and pawl guide 30. Pawl 20 engages a recess 41 in driven member 40. A plurality of recesses 41 are disposed about the inner perimeter of the driven member 40. Pawl 20 comprises a pin 21 by which it engages pawl guide 30. Pawl guide 30 engages a hub 42 of driven member 40. Hub 42 is connectable to a driven shaft (not shown).

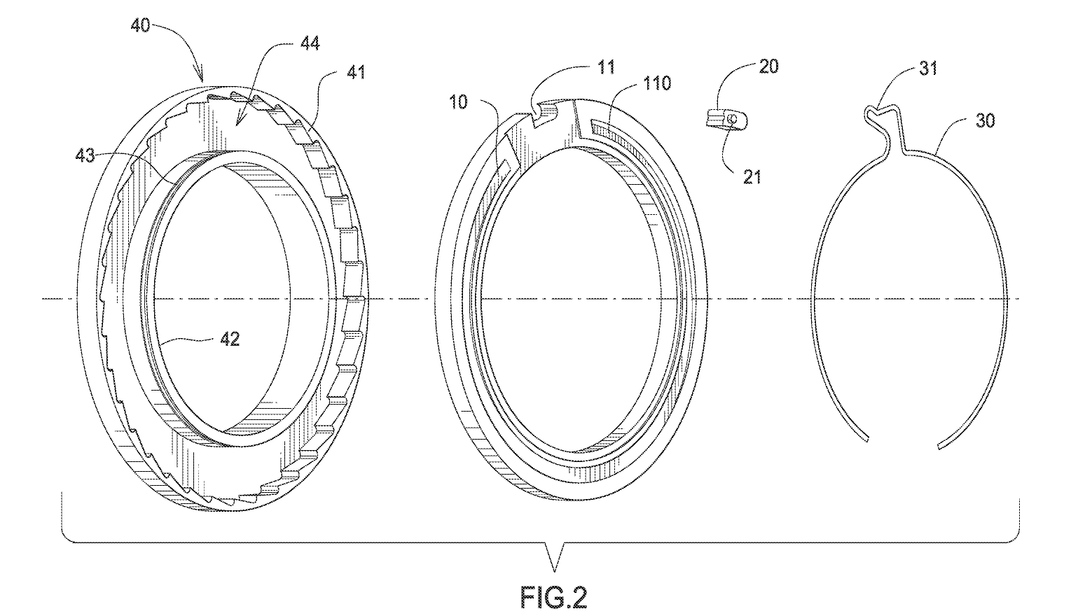

FIG. 2 is an exploded view of the device. Driver member 10 comprises a recess 11 which cooperatively receives pawl 20. Pawl guide 30 comprises a portion 31 which is configured to engage pin 21 of pawl 20. Pawl guide 30 may comprise spring steel or other suitably rigid material. Recesses 41 are disposed about the entire inner perimeter of driven member 40. Driver member 10 is cooperatively received in recess 44. Recess 44 extends about the entire circumference of driven member 40. Engaging driver member 10 within recess 44 allows pawl 20 to align with recesses 41. Recesses 41 are inclined at an angle θ to a tangent to driven member 40, see FIG. 1. Angle θ is in the range of greater than 0 degrees to approximately 30 degrees.

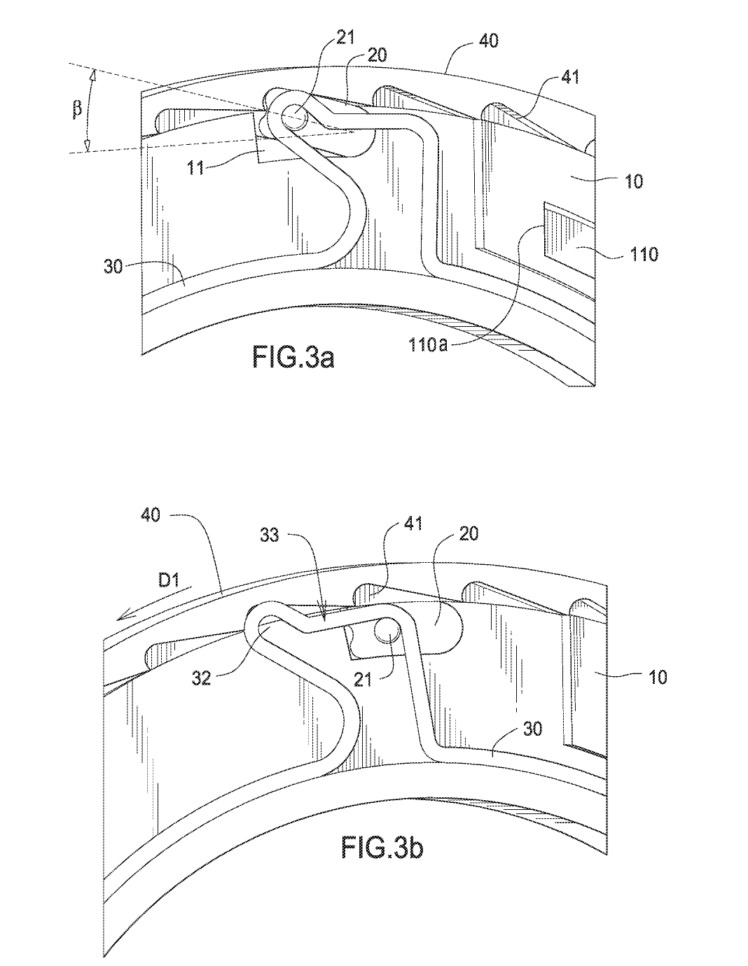

FIG. 3a is a detail of the device in the driving condition. Recess 11 of driver member 10 cooperatively receives the pawl 20. Pawl 20 is engaged with recess 41 and pawl guide 30. In the orientation shown in FIG. 3a, counter clockwise rotational power is transmitted from the driver member 10 to the pawl 20 to the driven member 40. Pawl 20 rotates radially outward to engage recess 41 in the driving condition by operation of in 21 translating within portion 32, see FIG. 3b. In the driving condition a driver portion (not shown) engages slot 110. A driver portion engages the end 110a of slot 110 in a driving direction. Slot 110 extends about an outer circumference of driver member 10.

FIG. 3b is a detail of the device in the overrun condition. Pawl 20 is shown with the clutch in the disengaged position. Pawl 20 is fully disengaged from driven member 40 and recess 41. This position occurs when the driven member 40 rotates faster than the driver member 10, also known as overrun. As one can see, pawl 20 is fully disengaged from recess 41 thereby allowing driven member 40 to rotate freely past the driver member 10 in the counter clockwise direction D1, known as the overrun condition.

As the overrun condition occurs pawl guide 30 rotates with driven member 40 because it is engaged with hub 42 in groove 43, and therefore pawl guide 30 rotationally temporarily overtakes driver member 10. In doing so, pin 21 of pawl 20 moves radially inward along guide 30 from portion 32 to portion 33. Portion 32 has a larger radius from the center of the device compared to the radius to portion 33 thereby causing the radially inward movement. Pin 21 engages portion 32 in the driving condition. Pin 21 engages portion 33 in the overrun condition. Movement from portion 32 to portion 33 causes pawl 20 to pivot and thereby retract from recess 41 in the overrun condition. Further, engagement of pin 20 with recess 11 facilitates retraction of pawl 20 in the overrun condition.

To reengage the pawl in the driving condition, pawl 20 and driver member 10 rotate relative to the driven member 40 and pawl guide 30 in direction D1. Pin 21 moves from portion 33 to portion 32 of pawl guide 30. This movement forces pawl 20 to pivot radially outward thus engaging with a recess 41. If the orientation is such that the pawl is not immediately in contact with a recess 41, the driver member 10 and pawl 20 rotate CCW together (direction D1) until the pawl contacts with the driven member recess 41, thus engaging the clutch assembly into the driving condition.

Pawl 20 pivots through an angle β of approximately 30 degrees as it moves from the overrun condition to the driving condition and vice versa.

FIG. 5 is a perspective view of an alternate embodiment. This alternate embodiment of the inventive device comprises a plurality of pawls 20 spaced radially around the device. Unless indicated otherwise, this alternate embodiment has the same pawls and features as described in this specification. Pawls 20 are shown in the overrun configuration in FIG. 5.

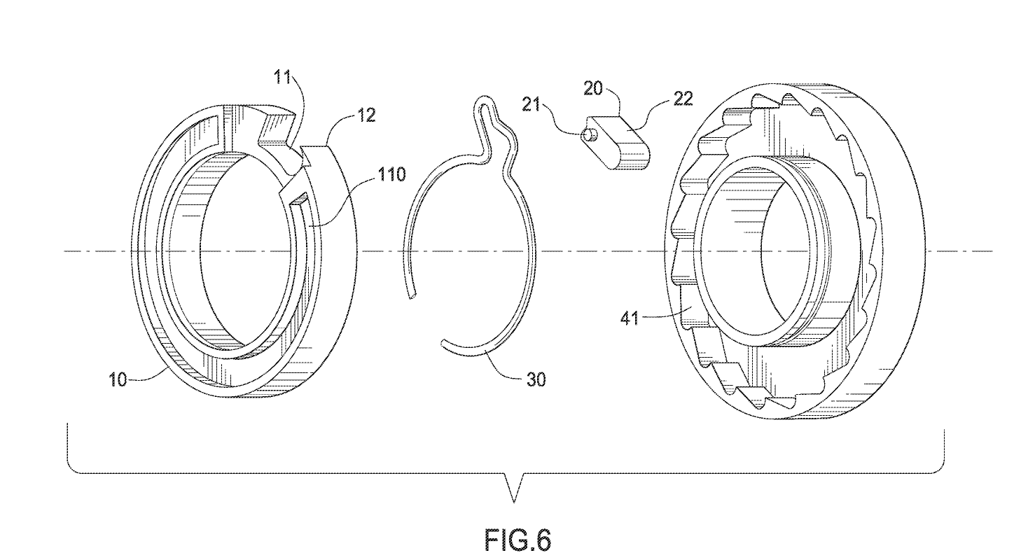

FIG. 6 is an exploded view of the device. In the overrun condition projecting portion 12 progressively engages pawl surface 22, thereby facilitating retraction of pawl 20 from recess 41 into receiving portion 11 during the overrun condition.

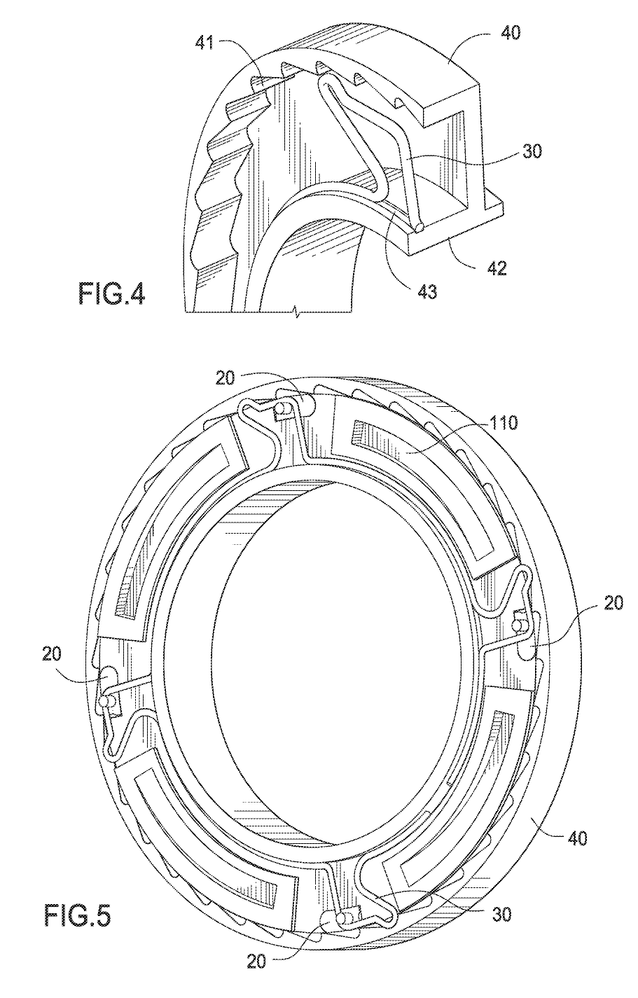

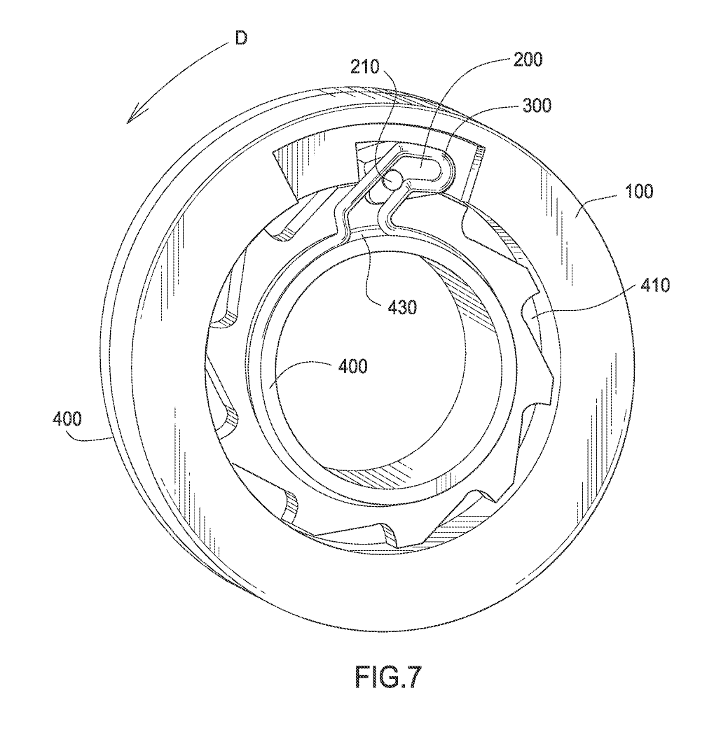

FIG. 7 is a perspective view of an alternate embodiment. Unless noted otherwise the components and manner of operation of this alternate embodiment is unchanged from the embodiment in FIGS. 1-6.

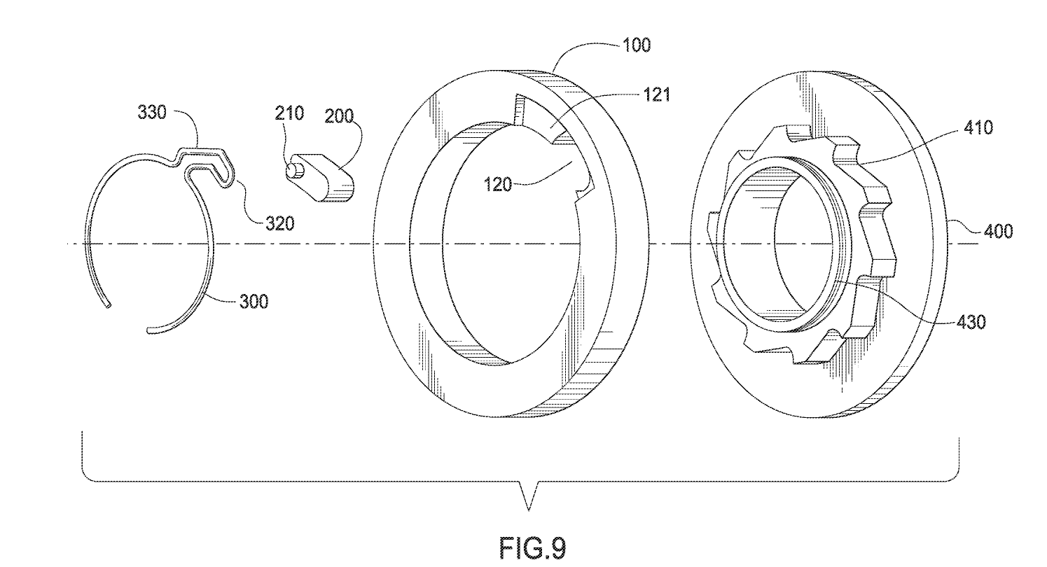

Driver member 100 is engaged. with driven member 400. Driven member 400 can engage an output shaft (not shown). Pawl 200 is cooperatively received in recess 120, see FIG. 9. Pawl 200 engages recess 410 in a driving condition. Pawl guide 300 retains and guides pin 210 and thereby pawl 200. Pin 210 is guided by pawl guide 300 in a like manner as described for pawl guide 30. Pawl 200 fully resides in recess 120 in the overrun condition so as not to engage a recess 410. Pawl guide 300 engages groove 430 in driven member 400.

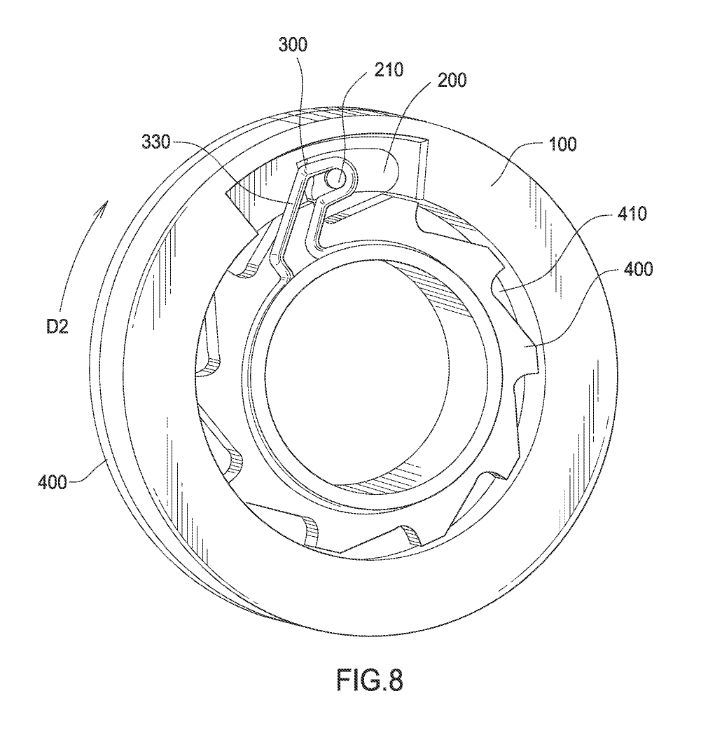

In the driving condition driver member 100 will rotate past the driven member 400 in direction “D”. Pawl. guide 300 is engaged with groove 430, causing it to rotate with driven member 400. As driver member 100 moves relative to driven member 400 in direction “D” pin 210 moves relative to pawl guide 300 in a radially inward direction along portion 330, see FIG. 8, thereby causing pawl 200 to engage recess 410. This in turn will drive driven member 400.

FIG. 8 is a perspective view of the alternate embodiment. In the overrun condition driver member 100 will move in direction “D2” relative to driven member 400. In doing so pin 210 will move relative to pawl guide 300 in a radially outward direction along portion 330 to portion 320, thereby causing pawl 200 to fully retract or disengage from recess 410 and thereby reengage recess 120, which allows driven member 400 to overrun driver member 100.

FIG. 9 is an exploded view of alternate embodiment. Driver member 100 comprises a recess 121 which cooperatively receives portion 330. This allows the overall thickness of the device in the axial direction to be kept to a minimum. Axial direction refers to the rotational axis of the device.

Although a form of the invention has been described. herein, it will be obvious to those skilled in the art that variations may be made in the construction and relation of parts without departing from the spirit and scope of the invention described herein.

I claim:

1. A one-way clutch comprising:
a driver member;
a driven member disposed radially outward of the driver member;
a pawl cooperatively engaged with a receiving portion in the driver member;
a recess in the driven member for receiving the pawl;
a pawl guide engaged with the driven member; and
the pawl engaged with the pawl guide, the pawl guide having a first portion and a second portion, the first portion urging the pawl radially outward to engage the recess for a driving condition and the second portion urging the pawl radially inward to disengage the recess for an overrun condition.

2. The one-way clutch as in claim 1, wherein the driven member comprises a groove for receiving the pawl guide.

3. The one-way clutch as in claim 1, wherein the pawl comprises a member for engaging the pawl guide.

4. The one-way clutch as in claim 1 further comprising a circumferential slot for receiving an input, torque.

5. The one-way clutch as in claim 1 comprising a plurality of pawls.

6. A one-way clutch comprising:
a driver member;
a driven member disposed radially inward of the driver member;
a pawl cooperatively engaged with a receiving portion in the driver member;
a recess in the driven member for receiving the pawl;
a pawl guide engaged with the driven member; and
the pawl engaged with the pawl guide, the pawl guide having a first portion and a second portion, the first portion orienting the pawl radially inward into contact with the recess for a driving condition and the second portion orienting the pawl radially outward out of contact with the recess for an overrun condition.

7. The one-way clutch as in claim 6, wherein the driven member comprises a groove for receiving the pawl guide.

8. The one-way clutch as in claim 6, wherein the pawl comprises a member for engaging the pawl guide.

9. The one-way clutch as in claim 6 comprising a plurality of pawls.

10. A one-way clutch comprising:
a driver member;
a driven member;
a pawl cooperatively engaged with a receiving portion in the driver member;
a pawl guide engaged with the driven member; and
the pawl engaged with the pawl guide, the pawl guide having a first portion and a second portion, the first portion urging the pawl into engagement with the driven member for a driving condition and the second portion urging the pawl to disengage from the driven member for an overrun condition.

11. The one-way clutch as in claim 10, wherein the driven member comprises a groove for receiving the pawl guide.

12. The one-way clutch as in claim 10, wherein the pawl comprises a pin member for engaging the pawl guide.

13. The one-way clutch as in claim 10 comprising a plurality of pawls.

14. The one-way clutch as in claim. 10 wherein the driver member is disposed radially inward of the driven member.

15. The one-way clutch as in claim 10 wherein the driver member is disposed radially outward of the driven member.

16. The one-way clutch as in claim 10, wherein the driven member comprises a recess for receiving the pawl.
